(19) United States
(12) Patent Application Publication
(10) Pub. No.: US 2016/0140559 A1
(43) Pub. Date: May 19, 2016

(54) PROCESSING SYSTEM

(71) Applicant: TRAVELEX LIMITED, London (GB)

(72) Inventors: Thomas Peter Jordan, London (GB); Philip David Hanson, London (GB); Jeremy Peter Jackson, London (GB)

(21) Appl. No.: 14/786,591

(22) PCT Filed: Apr. 17, 2014
(86) PCT No.: PCT/GB2014/051225

§ 371 Date: Oct. 23, 2015

(30) Foreign Application Priority Data
Apr. 23, 2013 (GB) 1307332.5

(51) Int. Cl. G06Q 20/40

(52) U.S. Cl. CPC G06Q 20/409

(57) ABSTRACT

The present invention provides processing system that comprises an issuer function and a merchant function as part of a card processor. The issuer function is arranged to receive a first authorisation request from a first card scheme administrator associated with a first transaction card, the first authorisation request relating to a card transaction made by a cardholder using the first transaction card at a card acceptor and including a number of data elements. A mapping function is provided in the card processor that is arranged to convert the first authorisation request into a second authorisation request, the second authorisation request relating to a transaction associated with an account held with an institution, wherein the mapping function is arranged to use contents of at least some of the data elements of the first authorisation request to form the second authorisation request. The merchant function is arranged to send the second authorisation request to the issuer of the institution of the account, and to receive a first authorisation response from the institution, the first authorisation response including a number of data elements. The mapping function is then arranged to convert the first authorisation response into a second authorisation response, the second authorisation response relating to the card transaction made by a cardholder, wherein the mapping function is arranged to use contents of at least some of the data elements of the first authorisation response to form the second authorisation response. The issuer function is arranged to send second authorisation response to the card acceptor via the first card scheme administrator.

The present invention relates to a processing system that enables a transaction of one type to be converted into a transaction of another type.

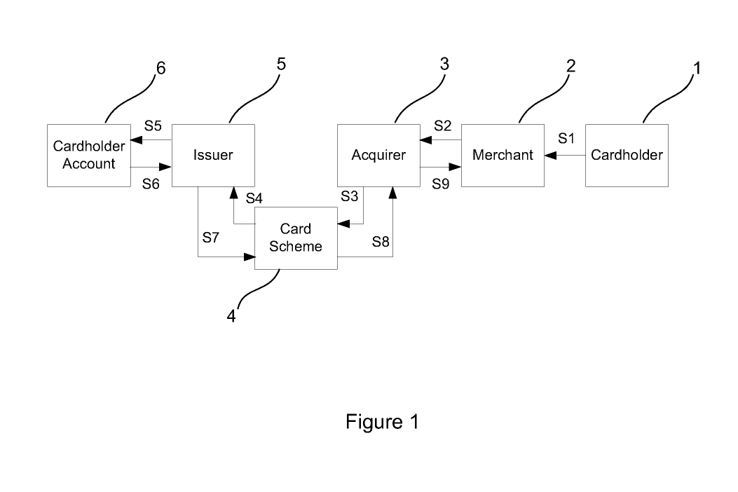

FIG. 1 shows a schematic diagram representing a conventional card payment system. As shown in FIG. 1, there is a card holder 1, a merchant 2, an acquirer 3, a card scheme 4, an issuer 5, and a card holder account 6. Although FIG. 1 shows a single acquirer 3, card scheme 4 and issuer 5, it will be appreciated that there may be many issuers, card schemes, acquirers and merchants connected to each other. A single entity of each type is shown for ease of illustration.

The card holder 1 obtains a transaction card from the issuer 5. The issuer 5 would typically be a retail banking or financial institution. Issuers 5 provide transaction cards for use at point of sale (POS) terminals located at a merchant 2. Transactions processed at POS terminals are acquired and processed by acquirers 3, and money is obtained from the issuer 5 via a card scheme administrator 4. Examples of card schemes include the MasterCard international (RTM), Visa international (RTM), Diners club (RTM) and American Express (RTM) schemes.

The card holder 1 uses their transaction card to make a financial transaction at the merchant 2 to buy goods or services (S1). For example, wherever the card holder 1 is the holder of a payment card they may use their card through a POS terminal provided on the premises of the merchant 2. It will be appreciated that before merchant 2 can deliver the goods or services desired by the card holder 1, the merchant 2 will need an assurance that they will be paid. As a result, an authorisation request is sent from the POS terminal to the issuer 5, in the manner described below.

The POS terminal extracts account details from the transaction card, including the card number that identifies the financial account of the card holder 1 with the relevant financial institution (i.e. the issuer 5). The POS terminal at the merchant 2 is connected or connectable to the acquirer 3 via a network. The account details and particulars of the transaction are sent to the acquirer by the merchant (S2) as part of an authorisation request. The particulars of a transaction may include the ID of the POS terminal, the ID of the merchant 2, the number of the transaction card, the value of the requested transaction, and the currency of the requested transaction.

The first digits of the transaction card number typically identify the appropriate card scheme. Upon receipt of the authorisation request including the transaction particulars, the acquirer 3 sends the authorisation request to the appropriate card scheme 4 (S3).

The card scheme administrator 4 identifies the appropriate issuer 5 based on the number of the transaction card. This may be achieved by examining the BIN number the number which is often the first six digits of the credit card. Each issuing bank is assigned one or more BIN numbers, so that all cards issued by the issuer 5 commence with those BIN numbers. Hence, using the BIN, the card scheme administrator 4 can send the authorisation request including the transaction particulars to the correct issuer 5 (S4).

On receipt of the authorisation request including the transaction particulars, the issuer 5 checks the card holder identity and approves/refers/declines the authorisation request, by checking details of the card holder account 6 (S5, S6). The issuer 5 may also undertake other checks (e.g. fraud checking).

The issuer 5 then sends an authorisation response back to the merchant 2. This is done in the reverse of the process for the authorisation request. In other words, the issuer 5 sends a message to the card scheme administrator 4 (S7), which then passes on the authorisation response message to the appropriate acquirer 3 (S8), which passes on the authorisation response message to the merchant 2 (S9). Then, if the transaction has been successful, the POS equipment at the merchant 2 indicates that the transaction has been approved, and the card holder 1 is free to obtain their goods or services.

The format of the authorisation request and authorisation response messages that pass between the entities in FIG. 1 are based on the ISO standard 8583. This standard specifies the data format of the messages, and has a strictly defined set of data elements.

If at any stage a message between two entities (e.g. between the acquirer 3 and the card scheme administrator 4) is not in the appropriate format, with the appropriate data elements, then the transaction will not be approved. Hence at every stage, each entity checks for the appropriateness of the message, and rejects the message if it is not in the appropriate format.

It will be appreciated that the merchant 2 could be a retailer with appropriate point of sale equipment, or could be an ATM. The same transaction flow would apply in each case.

A transaction of the type shown in FIG. 1 can be quoted to be a “card present transaction”. This is because the start of the process involves a card holder 1 presenting their card to a point of sale terminal at the merchant 2.

It will be appreciated that “card not present transactions” are also conventionally performed. Such card not present transactions are typically used for online purposes. In such card not present transactions, the card holder 1 will provide their card details (as opposed to the actual physical card) to the merchant 2, typically by providing their card number, expiry date and possibly other further authentication information. Once the merchant 2 has this information, the merchant 2 can send an authorisation request to the issuer 5 of the card holder in a similar way to the process described in FIG. 1.

An important difference between card present and card not present transactions is the content of the ISO 8583 message sent from the merchant to the issuer. In the authorisation request of a card not present transaction, the authorisation request clearly indicates that it is a card not present transaction as opposed to a card present transaction.

It is an aim of the invention to provide a processing system that has a number of benefits when compared to conventional processing systems

According to a first aspect of the invention, there is provided a processing system comprising: an issuer function arranged to receive a first authorisation request from a first card scheme administrator associated with a first transaction card, the first authorisation request relating to a card transaction made by a cardholder using the first transaction card at a card acceptor and including a number of data elements; a mapping function arranged to convert the first authorisation request into a second authorisation request, the second authorisation request relating to a transaction associated with an account held with an institution, wherein the mapping function is arranged to use contents of at least some of the data elements of the first authorisation request to form the second authorisation request; a merchant function arranged to send the second authorisation request to the institution of the account, and to receive a first authorisation response from the institution, the first authorisation response including a number of data elements; wherein the mapping function is arranged to convert the first authorisation response into a second authorisation response, the second authorisation response relating to the card transaction made by a cardholder, wherein the mapping function is arranged to use contents of at least some of the data elements of the first authorisation response to form the second authorisation response; wherein the issuer function is arranged to send the second authorisation response to the card acceptor via the first card scheme administrator.

In embodiments of the invention, the processing system is able to handle two streams of transaction processing in real time, acting as both the issuer for a card present transaction with a card acceptor, and a merchant in a second transaction. Hence, the processing system is able to convert a card present transaction into a second transaction.

In embodiments of the invention, the transaction process is in real time. The authorisation response to the card acceptor (i.e. the second authorisation response) is not provided by the issuer function until the authorisation response (i.e. the first authorisation response) is received by the merchant function.

As a result, the transaction can be made using a first transaction card (in either a card present or card not present transaction), with the funds being drawn from an account that is superficially unrelated to the first transaction card. Hence, the transaction can be made in real time using the first transaction card in a way that keeps the details of the account secret, thus improving security. It will be appreciated that the transaction made using the first transaction card could be in a card present manner (e.g. involving swiping the card at a POS terminal, using a chip and pin system at a POS terminal, or using an NFC or other wireless system in which the first transaction card is registered with a suitable device that communicates with a POS terminal) or as a card not present transaction (e.g. an online purchase).

If the first transaction card is lost or stolen, because the first transaction card has no link to the account at the institution, there is no need for the user to take any action with regard security of their account at the institution (e.g. change any website payment/billing details), unlike if the transaction card associated with their main bank account were lost or stolen.

In some embodiments, the conversion from the first authorisation request to the second authorisation request could comprise using data from the first authorisation request to form the second authorisation request, with the first authorisation and second authorisation requests having the same message format. In other embodiments, the first authorisation and second authorisation requests can have different message formats. In some embodiments, the second authorisation request can be formed based on (but not using in an exact form) data from the first authorisation request. In other embodiments, the second authorisation request can be formed by copying at least a portion of the data of the first authorisation request.

Likewise, the conversion from the first authorisation response to the second authorisation response could comprise using data from the first authorisation response to form the second authorisation response, with the first authorisation and second authorisation responses having the same message format. In other embodiments, the first authorisation and second authorisation responses can have different message formats. In some embodiments, the second authorisation response can be formed based on (but not using in an exact form) data from the first authorisation response. In other embodiments, the second authorisation response can be formed by copying at least a portion of the data of the first authorisation response.

In some embodiments, the first authorisation request could simply indicate that the transaction is accepted or declined. In such circumstances, the mapping function could simply use this information (e.g. along with information from the first authorisation request) to form the second authorisation response.

In some embodiments, the conversion from the first authorisation response to the second authorisation response comprises using data from the first authorisation request to form the second authorisation response.

The card acceptor could be a merchant, and ATM or any other point of transaction.

In some embodiments of the invention, the first authorisation request relates to a card present transaction, while in other embodiments the first authorisation request relates to a card not present transaction.

In some embodiments of the invention, the second authorisation request relates to a card not present transaction associated with a second transaction card, the second transaction card being associated with a second card scheme administrator and with an issuer of the account, and wherein the merchant function is arranged to send the second authorisation request to the issuer of the second transaction card via the second card scheme administrator, and to receive a first authorisation response from the second card scheme administrator. In such embodiments, the merchant function can be arranged to send the second authorisation request to an acquirer or to the second card scheme administrator. In other words, the merchant function can act as a “merchant” or a “merchant/acquirer”.

In some embodiments of the invention, a cardholder is able to make transactions using the first transaction card, while taking funds from the account associated with the second transaction card, while protecting the card details (card number, expiry date etc) of the second transaction card as well as physical second transaction card itself. This provides a reduced risk of fraud and greater convenience to the user in the event of the loss or theft of the transaction card used to make purchases. This is because the transaction card associated with the cardholder's account (i.e. the second transaction card) is not used directly for the transaction.

Although some embodiments relate to conversion of a card present transaction with a first transaction card to a card not present transaction with a second transaction card, it will be appreciated that embodiments of the invention are equally applicable to the conversion of a card not present transaction with a first transaction card to a card not present transaction with a second transaction card. Such scenarios could be used, for example, to use the first transaction card in an online transaction, while obtaining the funds from an account associated with the second transaction card

In some embodiments, the authorisation request and authorisation response messages can have the form defined in the ISO 8583 standard. In other embodiments, it will be appreciated that other message formats may be used.

In some embodiments of the invention, the first and second card scheme administrator are part of the same or different card schemes.

In some embodiments of the invention, the processing system further comprises a rules database, the rules database storing a set of rules used by the mapping function to convert the first authorisation request into the second authorisation request, and to convert the first authorisation response into the second authorisation response.

In some embodiments of the invention, the mapping function is arranged to store the content of the data elements that are changed in the first authorisation request, and to use this stored content when converting the first authorisation response into the second authorisation response.

In some embodiments of the invention, the card transaction made by the cardholder at the merchant is associated with an amount in a first currency, and the account is associated with a second currency; wherein to form the second authorisation request the mapping function is arranged to change a value of a data element of the first authorisation request indicating the amount in the first currency with a value indicating an amount in the second currency.

In such embodiments, in multi-currency environments, a foreign merchant is to receive payment in their currency in a card transaction, with the card holder having the amount in their local currency debited from their account.

In some embodiments of the invention, the processing system further comprises a foreign exchange database arranged to store currency conversion information, wherein the mapping function is arranged to use the currency conversion information to change the value of the data element of the first authorisation request indicating the amount in the first currency with the value indicating the amount in the second currency.

In some embodiments of the invention, on receipt of the first authorisation response, the mapping function is arranged to change the value of a data element of the first authorisation response indicating the amount in the second currency with the a value indicating the amount in the first currency.

In some embodiments of the invention, the first authorisation request contains a data element indicating that the there is to a be conversion from the first currency to the second currency, and wherein the mapping function is arranged to change a value of the data element of the first authorisation request associated with the conversion from the first currency to the second currency with a value indicating that there is no currency conversion required to form the second authorisation request.

In some embodiments of the invention, the issuer function is associated with a third currency, and wherein the first authorisation request contains a data element indicating that the there is to a be conversion from the first currency to the third currency, and wherein the mapping function is arranged to substitute a value of the data element of the first authorisation request associated with the conversion from the first currency to the second currency with a value indicating that there is no currency conversion required to form the second authorisation request.

In some embodiments of the invention, the issuer function is associated with the same currency as the merchant.

Embodiments of the present invention will now be described, by way of example only, with reference to the accompanying drawings, in which:

FIG. 1 shows a schematic diagram of a conventional transaction flow;

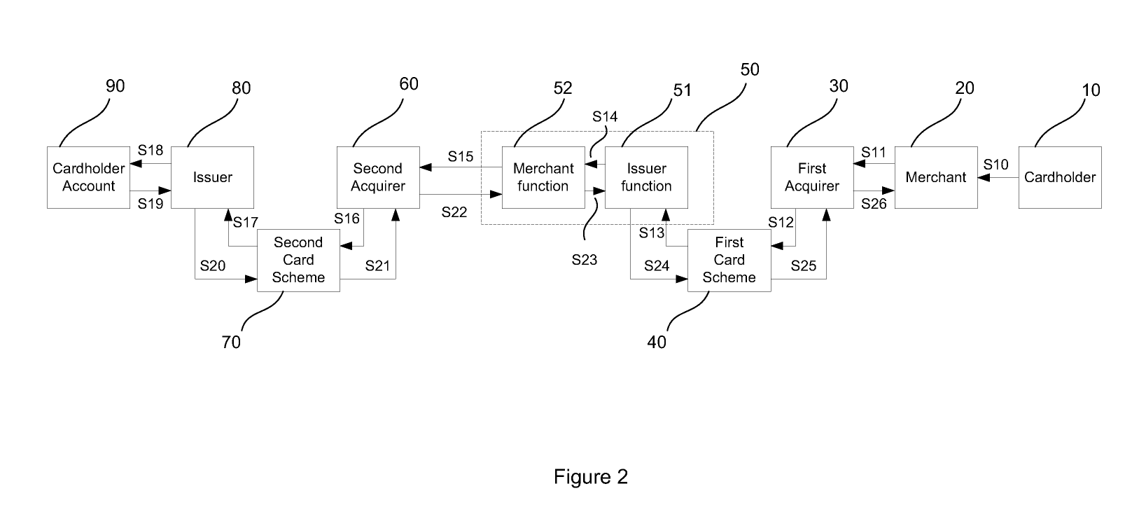

FIG. 2 shows a schematic diagram of a transaction flow according to a first embodiment of the invention;

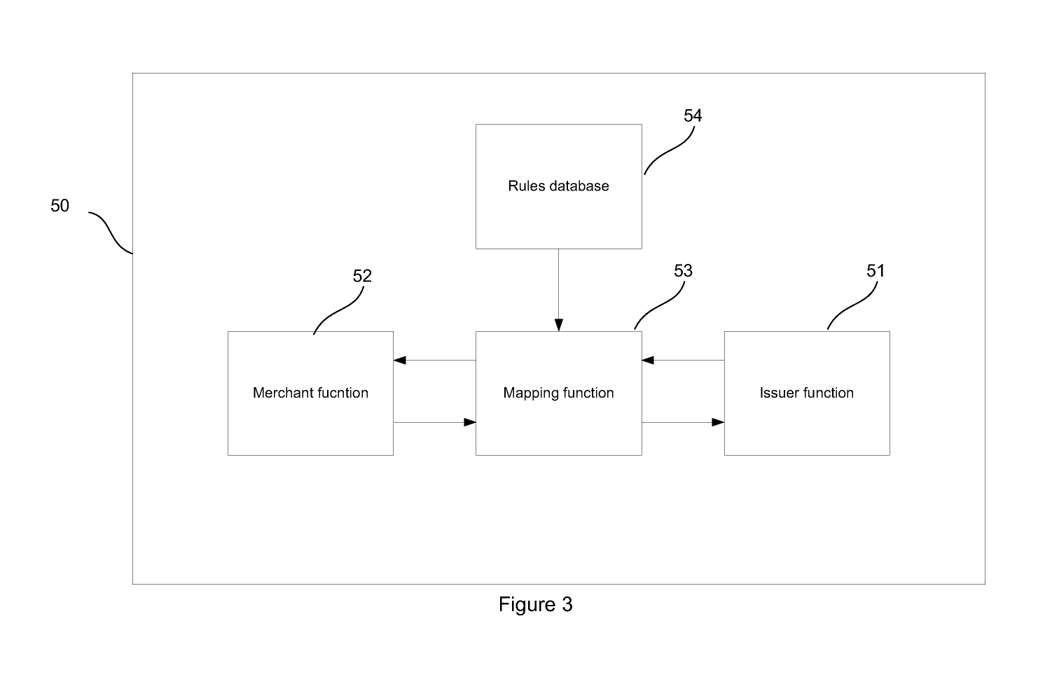

FIG. 3 shows a schematic diagram of a card processor according to the first embodiment of the invention;

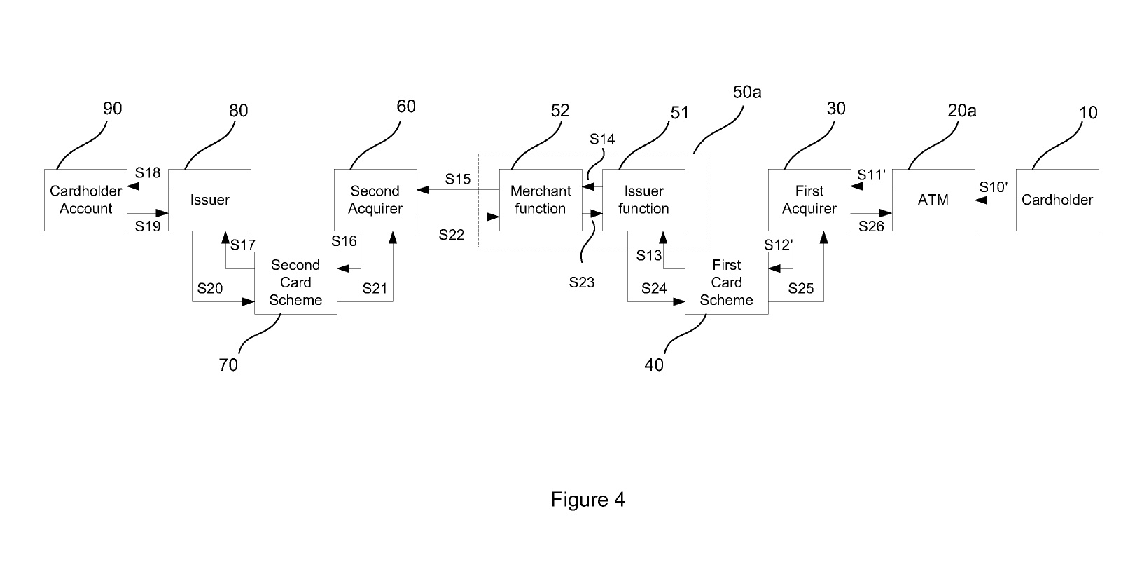

FIG. 4 shows a schematic diagram of a transaction flow according to a second embodiment of the invention;

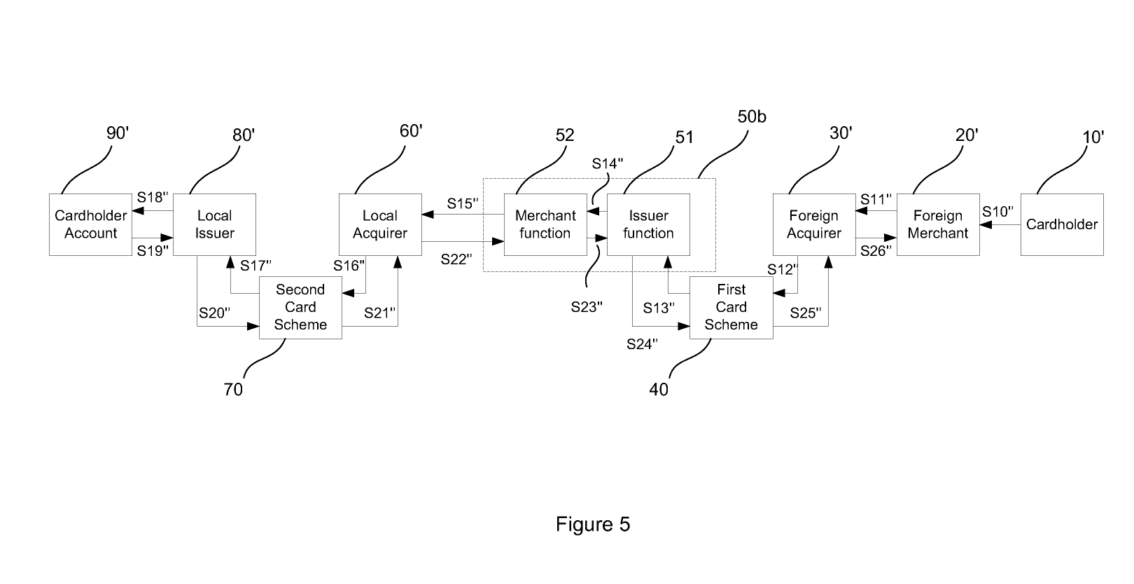

FIG. 5 shows a schematic diagram of a transaction flow according to a third embodiment of the invention;

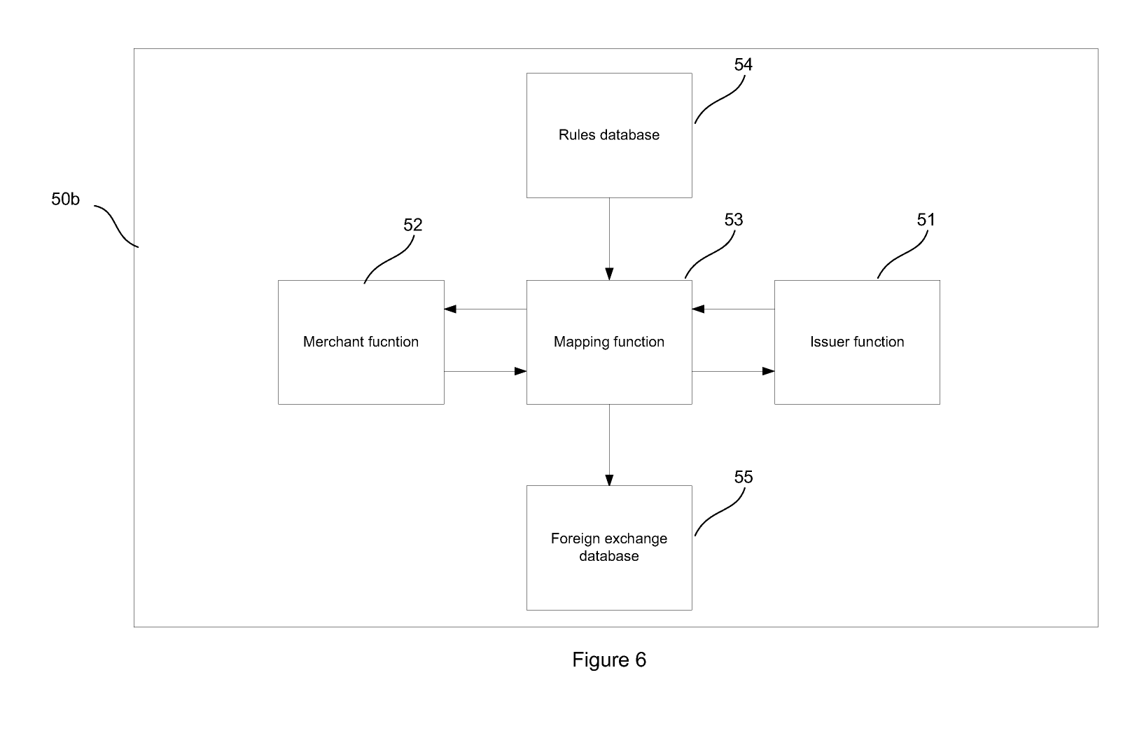

FIG. 6 shows a schematic diagram of a card processor according to the third embodiment of the invention; and

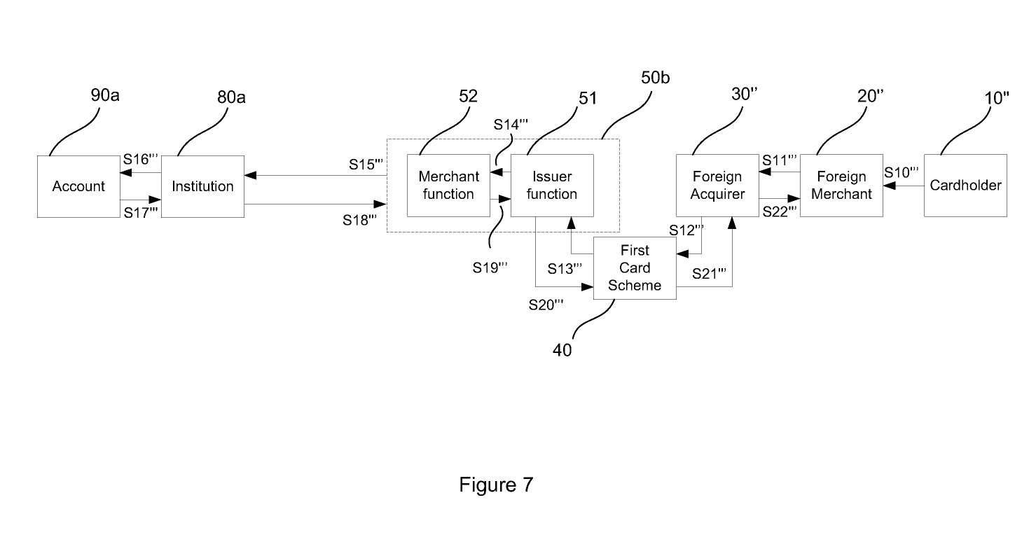

FIG. 7 shows a schematic diagram of a transaction flow according to a fourth embodiment of the invention.

FIG. 2 shows a schematic diagram of a transaction processing system according to a first embodiment of the invention. In this embodiment there is a card holder 10, a merchant 20, a first acquirer 30, a first card scheme administrator 40, and a card processor 50. The card processor 50 is connected to a second acquirer 60, a second card scheme administrator 70, an issuer 80 and a card holder account 90. The first card scheme administrator 40 can be the part of the same card scheme as the second card scheme administrator 70, or part of a different card scheme.

As shown in FIG. 3, the card processor 50 comprises an issuer function 51, a merchant function 52, a mapping function 53, and a rules database 54.

As will be explained in more detail, card processor 50 handles two streams of transaction processing in real time, both acting as the issuer for a card present transaction, and a merchant in a card not present transaction.

In the embodiment of FIG. 2, the card holder 10 has two separate transaction cards. The card holder 10 has a first transaction card that is specially adapted for this embodiment of the present invention, and that identifies the issuer function 51 as the “issuer” of the first transaction card. The first transaction card is associated with the card scheme of the first card scheme administrator 40.

The card holder 10 also has a second transaction card, which is a conventional transaction card (e.g. credit card, debit card, prepaid card, etc), which is associated with associated with a second card scheme administrator 70 and with an issuer 80, where the card holder 10 has a card holder account 90. The card holder 10 will register the second transaction card with the card processor 50, which will store the link between the first transaction card and the second transaction card.

As for FIG. 1, the process of FIG. 2 starts with the card holder 10 presenting their transaction card to the merchant 20. For example, the card holder 10 could swipe their transaction card through a POS terminal on the premises of the merchant 20 (S10). Then, the POS terminal of the merchant 20 sends the account details and particulars of the transaction to the first acquirer 30 (S11) in a first authorisation request. The transaction particulars may include the ID of the POS terminal, the ID of the merchant 20, the number of the first transaction card, the value of the requested transaction, and the currency of the requested transaction.

On receipt of the transaction particulars, the first acquirer 30 sends the transaction particulars in the first authorisation request to the appropriate card scheme 40 (S12). The card scheme 40, which can be considered as a first card scheme in FIG. 2, then examines the BIN number of the transaction card to determine the issuer associated with the transaction card. It will be appreciated that there may be other routing factors that are considered in addition to the BIN, but the BIN will be one of the key factors.

In contrast to the arrangement of FIG. 1, the first transaction card of the card holder 10 is not associated with a conventional issuer. Instead, in the arrangement of FIG. 2, the card scheme 40 will identify that the BIN number of the first transaction card used by the card holder 10 is associated with the issuer function 51 of the card processor 50, as opposed to with a conventional card issuer.

Hence, the first card scheme 40 will send the transaction particulars in the first authorisation request to the issuer function 51 (S13), as if the issuer function 51 were a conventional issuer. The issuer function 51 of the card processor 50 is not itself an issuer in the conventional sense, but the issuer function 51 acts as a gateway between the merchant 20 and the card holder's account 90 and the local issuer 80.

The role of the card processor 50 is to translate a first authorisation request made by the first transaction card in a card present transaction, into a second authorisation request for the second transaction card in a card not present transaction. The card processor 50 achieves this by means of the issuer function 51 and the merchant function 52, the mapping function 53, and the rules database 54.

On receipt of the transaction particulars in the authorisation request, the issuer function 51 will process the message and pass it to the mapping function 53, as shown in more detail in FIG. 3.

The mapping function 53 converts the first authorisation request received from the first card scheme 40, which is a card present authorisation request, into a card not present authorisation request (second authorisation request) based on the second transaction card for the issuer 80. The mapping function 53 does this by using a set of rules provided by the rules database 54.

The rules in the rules database 54 determine how to convert the first authorisation request into the second authorisation request. For example, the first card scheme 40 could be different to the second card scheme 70, and the content of an authorisation request suitable for the first and second card schemes could be different. Furthermore, in practical embodiments, the card processor may be connected to a number of different card schemes for various types of transaction cards, each having their defined set of rules for the content of the authorisation request. The rules database 54 contains the information that enables the authorisation request associated with the first transaction card to be converted into an authorisation request associated with the second transaction card.

The conversion process is performed in real time by changing the values of data elements in the first authorisation request to form the second authorisation request. More detail on the conversion process is provided below.

Then, the mapping function 53 provides the converted first authorisation request to the merchant function 52. The merchant function 52 then provides a second authorisation request to the second acquirer 60 (S15) based on the converted first authorisation request.

The second acquirer 60 then provides the second authorisation request to the second card scheme 70 (S16), which in turn provides the second authorisation request to the correct issuer 80, on the basis of the BIN number of the second transaction card (S17). Hence, the mapping function 53 converts the first authorisation request based on a card present transaction associated with the card holder's first transaction card, to a second authorisation request associated with the card holder's second transaction card.

The issuer 80 then queries the card holder account 90, and approves/refers/declines the transaction on the basis of the funds available in the card holder account 90 (S18, S19). The issuer 80 is an institution (e.g. a bank or other financial institution) holding the card holder account 90.

The issuer 80 then sends a first authorisation response to the second card scheme 70 (S20), which in turn provides the first authorisation response to the acquirer 60 (S21). The acquirer 60 then provides the merchant function 52 with the first authorisation response (S22).

Then, the merchant function 52 provides the first authorisation response to the mapping function 53, which converts the first authorisation response into a second authorisation response relating to the card present transaction made by a cardholder 10 using the information provided in the rules database 54. This process mirrors the process of converting the first authorisation request into the second authorisation request, and involves replacing the values of data elements in the first authorisation response with those from the first authorisation request, in order to form the second authorisation response. The conversion process is performed in real time by changing the values of data elements in the first authorisation response to form the second authorisation response.

In other words, the mapping function 53 converts the authorisation response from the issuer 80 into an authorisation response suitable for the merchant 20 (S23).

The issuer function 51 then sends the second authorisation response message to the first card scheme 40 (S24), which in turn provides the second authorisation response message to the first acquirer 30 (S25), which then provides the response message to the merchant 20 (S26). On the basis of the received second authorisation response, the transaction at the merchant 20 is then either shown as being approved, referred or declined.

Hence, as a result of the arrangement of FIG. 2, the card holder 10 is able to make a transaction at the merchant 20 using a first transaction card in the way of a card present transaction, with the card holder's issuer 80 being provided with a authorisation request associated with a card not present transaction associated with a second transaction card. Hence, the arrangement of FIG. 2 converts a card present transaction into a card not present transaction.

It will be appreciated that the merchant 20 could be a retailer with appropriate point of sale equipment, or could be an ATM. The same transaction flow would apply in each case.

In order to transform card processing for multiple issuers and card schemes, the rules database 54 includes the logic used to convert the first authorisation request into the second authorisation request, and the first authorisation response into the second authorisation response.

It will be appreciated that the authorisation request and authorisation response messages will have the form defined in the ISO 8583 standard. Such messages include a number of data elements. In converting from the first authorisation request (card present transaction) into the second authorisation request (card not present transaction), the values of a number of the data elements of the first authorisation request need to be changed to form the second authorisation request. For example, one of the data elements in the first authorisation request will specify that it is a card present transaction, and the content of this data element will need to be changed to the value indicating a card not present transaction in the second authorisation request.

Also the data elements that specify that the first authorisation request is from the merchant 20 (e.g. merchant name and location) need to be changed to values that indicate that the second authorisation request is from the merchant function 52 of the card processor 50.

Also, certain data elements of the first authorisation request will relate to the first transaction card. These data elements will need to be changed to relate to the second transaction card

In this way, by changing the values of certain data elements the mapping function 53 can convert the first authorisation request (card present transaction) into a valid second authorisation request (card not present transaction).

In the return leg (i.e. conversion from the first authorisation response to the second authorisation response), the data elements in the first authorisation response specifying that the transaction is a card not present transaction need to be changed to the value indicating a card present transaction in the second authorisation response. Also, the data elements of the first authorisation response that relate to the second transaction card need to be changed to relate to the first transaction card. In addition, any information in the first authorisation request relating to the merchant 20 that was replaced to form the second authorisation request needs to be replaced when forming the second authorisation response.

In such an embodiments, the transaction process is in real time, and the authorisation response to the merchant 20 (i.e. the second authorisation response) is not provided by the issuer function 51 until the authorisation response (i.e. the first authorisation response) is received by the merchant function 52.

The data elements that need to be changed will be specific for the card schemes 40 and 70 used by the first and second transaction cards. Additionally, it is possible that different merchants and acquirers may require different rules. All such information can be stored in the rules database 54.

It will be appreciated that settlement and clearing will not occur in real time. Settlement may begin with the merchant 20 sending a batch settlement file to the first acquirer 30, which in turn will pass a batch settlement file to the first card scheme 40. The first card scheme 40 will then seek settlement from the issuer function 51 of the card processor 50. In some embodiments, it is not necessary for the merchant 20 to send a batch settlement file to the first acquirer 30, as the first acquirer 30 may already have this data.

Once this has occurred, the merchant function 52 of the card processor 50 will send a batch settlement file to the second acquirer 60, which in turn will pass a batch settlement file to the second card scheme 70. The second card scheme 70 will then seek settlement from the issuer 80. Alternatively, the merchant function 52 may submit a settlement file before the first card scheme settlement process.

The merchant function 52 of the card processor 50 will then receive the settlement from the issuer 80 via the second acquirer 60. The card processor 50 will then perform reconciliation between the amount it provided to the first card scheme 40 and the amount it received from the second card scheme 70.

There are a number of uses of the arrangement of FIG. 2, and a number of different examples will be provided below.

In the arrangement of FIG. 2, a cardholder 10 is able to make transactions using the first transaction card, while taking funds from the cardholder account 90 associated with the second transaction card, while protecting the card details (card number, expiry date etc) of the second transaction card as well as physical second transaction card. This has a number of benefits.

Many people have a current account that they use as their main bank account, into which their wages are paid, and out of which their regular bills (e.g. utility bills, rent or mortgage payments) are paid out. Such a current account would typically be associated with a transaction card, which in this case would be a debit card. Also a typical user would have the card details of such a transaction card stored with a number of online merchants.

If this debit transaction card were to be lost or stolen, there would be a fraud risk that the contents of the account 90 would be at risk of fraud. This risk may be magnified for debit cards when compared to credit cards, as credit cards are typically associated with higher levels of fraud protection when compared to debit cards.

Furthermore, a typical debit card in the UK has a card number (16 digits), as well as indicating the account number and sort code of the cardholder account 90. While a replacement card could have a different expiry date and 3-digit security code, the account number and sort code will stay the same as for the lost card (as both the replacement card and the lost card relate to the same current account).

Hence, if the cardholder has the transaction card associated with their main bank account stolen, then even after a replacement card has been obtained (with new expiry date and 3-digit security code), the account number and sort code will remain at risk. Therefore, there is a permanent risk of fraud associated with that bank account if the transaction card associated with it is lost or stolen, and that bank account would need to be closed to completely eliminate this risk of fraud.

In addition to the fraud risk associated with losing or having stolen such a debit card, such loss of a debit card would be a significant inconvenience for the cardholder. Typically when a transaction card (whether credit or debit) is lost or stolen it is necessary for the cardholder to obtain a replacement card. The replacement card will often have different details to the previous card (for example a different expiry date and 3-digit security code). As a result, the cardholder will need to update any websites/payment schemes that have the stored details of their card with the card details of the replacement transaction card.

As a result, it will be appreciated that the loss of a transaction card that is linked to the cardholder's account 90 is associated with fraud risk and significant inconvenience to the user.

In addition, another risk avoided by this is the fact that the cardholders debit card details are not shared with the first merchant. Hence, there is protection in the event the first merchant is compromised in any way (internal fraud or external fraud via data compromise, etc.).

By using the system of FIG. 2, the fraud risk and inconvenience to the cardholder can be reduced. This is because the cardholder can use the transaction card associated with their main bank account as the second transaction card in the scheme of FIG. 2. Thus, the cardholder can make purchases using the first transaction card as card present transactions, while protecting the card details and physical transaction card associated with their main bank account (i.e. the second transaction card in the embodiment of FIG. 2).

If the first transaction card is lost or stolen, there is a still an immediate fraud risk until the first transaction card is cancelled. However, after the first transaction card is cancelled, the card processor 50 can be arranged to completely block the first transaction card from accessing the funds of the cardholder account 90. Furthermore, once the first transaction card is cancelled, there is no information on it (e.g. account number and sort code) linking the first transaction card to the cardholder account 90, unlike if the transaction card associated with their main bank account (i.e. the second transaction card) were lost or stolen.

Also, if the first transaction card is lost or stolen, because there is no link to the cardholder account 90, there is no need to change any website payment/billing details, unlike if the transaction card associated with their main bank account (i.e. the second transaction card) were lost or stolen.

This arrangement of FIG. 2 therefore enables payments to be made from a cardholder account 90 while protecting details of the cardholder account 90, thus decreasing the risk of fraud and increasing convenience to the cardholder in the event that the first transaction card is lost or stolen.

This is particularly useful for cardholders who only have a debit card associated with their main bank account (e.g. those ineligible for credit cards). For example, such a cardholder may decide that using their debit card associated with their main bank account in some circumstances is too risky. For example, when they are travelling and perceive that they have a greater risk of losing or having their card stolen.

In addition, it will be appreciated that for some embodiments, the functions of one or more of the second acquirer 60, second card scheme 70 and second issuer 80 can be combined. For example, a single entity (on one or more servers) may carry out the function of one or more of the second acquirer 60, second card scheme 70 and second issuer 80.

Furthermore, it will be appreciated that the merchant function 52 could also act as the “second acquirer 60”. In other words, the role of the merchant function 52 could also be to act as the second acquirer 60, sending the second authorisation request to the second card scheme 70.

An embodiment of the invention that is suitable for enabling an online retailer to accept payments with higher security in shown in FIG. 4. In this figure, entities with the same function as those with FIG. 2 are shown with the same reference number

This embodiment can be used to enable a customer to pay for goods or services at an online merchant, which conventionally requires the use of a card not present transaction, with the added security of a card present transaction.

It will be appreciate that card present transactions are associated with a higher security level than a card not present transaction. This is because a card present transaction requires the physical presence of a transaction card, and in the case of chip and pin arrangements, requires the user entering a pin associated with the card.

For an online merchant, a card present transaction is not possible, as the online merchant has no physical presence.

In this embodiment, the card processor 50a is associated with the online merchant. For example the card processor 50a could be a server maintained by the online merchant. Conventionally, this online merchant would carry out a transaction flow as a card not present transaction in the conventional manner. However, in this embodiment, the online merchant carries out a transaction flow with the various entities shown in FIG. 4.

In this embodiment, the online merchant provides the card holder with a first transaction card associated with the online merchant. The online merchant also requires the card holder 10 to be provided with details of a second transaction card, e.g. a conventional credit or debit card, which is associated with the issuer 80 of the card holder 10 and linked to the cardholder account 90.

Instead of the online merchant carrying out a card not present transaction using the second card of the card holder (i.e. the conventional credit or debit card) in the normal manner, the online merchant accepts transactions using the first card in a card present transaction.

In this embodiment, the card holder 10 presents the first transaction card at the ATM 20a (S10′). In this embodiment, the ATM 20a is adapted for use in this embodiment of the invention. When the first transaction card is provided to the ATM 20a, the ATM 20a provides the user with an appropriate user interface to enable the user to use of pay for goods or services from the online merchant. For example, the user may have already chosen the goods to buy on the online merchant, and the ATM 20a would present the selection of goods and request confirmation that payment is to be authorised.

Then, when the card holder selects the appropriate option on the specially adapted ATM 20a, the ATM 20a will send a first authorisation request to the first acquirer 30 (S11′). The first acquirer 30 will then pass this first authorisation request on to the first card scheme administrator 40 (S12′), which will then pass this authorisation request on to the issuer function 51 of the card processor 50a.

In a similar way as described in FIGS. 2 and 3, the issuer function 51 will provide this message to the mapping function 53, which will convert the first authorisation request into a second authorisation request, the second authorisation request relating to a card not present transaction associated with a second transaction card, using the information provided in the rules engine 54.

The merchant function 52 of the card processor 50a will then send a second authorisation request to the issuer 80 in the same way as described in relation to FIG. 2.

If a transaction is approved, then a first authorisation response will be sent from the issuer 80 to the merchant function 52, and this will be converted by the mapping function 53 into a second authorisation response, which will be sent by the issuer function 51 to the ATM 20a.

On receipt of the second authorisation response, the ATM 20a can then inform the card holder whether the transaction was successful or unsuccessful. If a transaction was successful, then goods or services would be provided by the online merchant to the card holder in the usual way (e.g. by postal delivery).

Hence, in the above embodiment, an online merchant can provide the added security of a card present transaction scheme. Using such an arrangement, the online merchant can use the existing ATM network in order to provide this functionality. Alternatively, it will be appreciated that the same functionality could be provided by adapted point of sale equipment in different merchants.

An embodiment of invention that is suitable for enabling a card holder to make payments in a foreign country will now be described.

Referring back to the conventional transaction scheme shown in FIG. 1, it will be appreciated that a card holder's account 6 at the issuer 5 will be associated with one currency (e.g. British pounds), typically the local currency of the card holder 1. If the card holder 1 goes to a merchant 2 in their local country, then the merchant 2 would expect to receive payment in the same local currency as the card holder account 6. In such a scenario, there is clearly no need for any currency conversion to take place.

The same process does, however, apply when the card holder 1 travels to a foreign country. For example, in the case of the card holder's account 6 being in British pounds, the card holder 1 may travel to the USA on holiday. If the card holder 1 goes to a merchant 2 in the USA, then the merchant 2 will expect payment in US dollars. In such a scenario, the card scheme administrator 4 would recognise that the card holder is associated with an issuer 5 in the UK, and would apply a foreign exchange conversion to the transaction particulars in the authorisation request, and indicate in the first authorisation request that a currency conversion is to take place.

In other words, if the card holder 1 is attempting to buy goods to the value of $100, the card scheme administrator 4 will make a conversion and pass the authorisation request to the issuer 5 requesting an amount of money in British pounds at a rate determined by the card scheme administrator 4 (sometimes factoring charges set by the issuer).

While this arrangement solves the problem of multi-currency transactions, it has a disadvantage from the card holder's 1 point of view in that a rate of exchange is set by the card scheme administrator 4. Such an exchange rate (along with issuer fees) is unlikely to be favourable to the card holder 1 and moreover the card holder 1 may not be aware of the exchange rate at the time of purchase of the goods.

This identified problem led to the development of dynamic currency conversion (DCC). DCC allows a card holder 1 to conduct a transaction at a merchant 2 in their local currency instead of the local currency of the merchant 2. The advantage of DCC is that, if used in the right circumstances, the card holder 1 can see the exact value that will appear in their statement of account from their issuer 5 at the time of transaction. In DCC transactions, it is the acquirer 3 that attends to the necessary foreign exchange, instead of the card scheme administrator 4 (and avoiding issuer fees).

One method of completing a DCC transaction is for the POS terminal at the merchant 2 to request the associated amount (in the cardholders currency) from the Acquirer related to the specific amount. The POS terminal can then display the local currency of the card holder 1 as an option for performing the transaction. Hence, in a DCC transaction, the card holder 1 is presented with either paying for the good or services in the local currency of the merchant (e.g. US dollars), or paying in their own local currency.

FIG. 5 shows a schematic diagram of a transaction processing system according to a third embodiment of the invention. In this figure, entities with the same function as those with FIG. 2 are shown with the same reference number.

In this embodiment there is a card holder 10′, a foreign merchant 20′, a foreign acquirer 30′, a first card scheme administrator 40, and a card processor 50b. The card processor 50b is connected to a local acquirer 60′, a second card scheme administrator 70, a local issuer 80′ and a card holder account 90′. As for the other embodiments of the invention, the first card scheme administrator 40 can be the part of the same card scheme as the second card scheme administrator 70, or part of a different card scheme.

As shown in FIG. 6, the card processor 50b comprises an issuer function 51, a merchant function 52, a mapping function 53, a rules engine 54, and a foreign exchange database 55.

In this example, the card holder 10′ wishes to buy goods from a foreign merchant 20′. For example, the card holder 10′ could be a UK resident, who is on holiday in the USA.

In the arrangement of FIG. 5, the card holder 10′ has two separate transaction cards. The card holder 10′ has a first transaction card that is specially adapted for this embodiment of the present invention, and that identifies the issuer function 51 as the “issuer” of the first transaction card. The first transaction card is associated with the card scheme of the first card scheme administrator 40. In this embodiment, the first transaction card is a card linked to the local currency of the cardholder 10′.

The card holder 10′ also has a second transaction card, which is a conventional credit or debit card, which is associated with a second card scheme administrator 70 and with the local issuer 80′, where the card holder 10′ has a card holder account 90′. The card holder 10 registers the second transaction card with the card processor 50b.

The process of FIG. 5 starts with the card holder 10′ presenting their transaction card to the foreign merchant 20′. For example, the card holder 10′ could swipe their transaction card through a POS terminal on the premises of the merchant 20′ (S10″). Then, the POS terminal of the foreign merchant 20′ sends the account details and particulars of the transaction to the foreign acquirer 30′ (S11″) in a first authorisation request. The transaction particulars may include the ID of the POS terminal, the ID of the foreign merchant 20′, the number of the first transaction card, the value of the requested transaction, and the currency of the requested transaction.

On receipt of the transaction particulars, the foreign acquirer 30′ sends the transaction particulars in the first authorisation request to the appropriate card scheme 40 (S12″). The card scheme 40, which can be considered as a first card scheme in FIG. 5, then examines the BIN number of the transaction card to determine the issuer associated with the transaction card.

As for the arrangement of FIG. 2, the first transaction card of the card holder 10′ is not associated with a conventional issuer. In the arrangement of FIG. 5, the first card scheme 40 will identify that the BIN number of the transaction card used by the card holder 10′ is associated with the issuer function 51 of the there is a card processor 50b, as opposed to a conventional card issuer. Hence, the first card scheme 40 will send the transaction particulars in the first authorisation request to the issuer function 51 (S13″), as if the issuer function 51 were a conventional issuer.

The role of the card processor 50b is to translate a first authorisation request made by the first transaction card in a card present transaction, into a second authorisation request for the second transaction card as a card not present transaction, and to take care of the currency conversion required as a result of the card present transaction involving a foreign merchant 20′. The card processor 50b achieves this by means of the issuer function 51 and the merchant function 52, the mapping function 53, the rules database 54 and the foreign exchange database 55 shown in FIG. 6.

On receipt of the transaction particulars in the authorisation request, the issuer function 51 will process the message and pass it to the mapping function 53.

The mapping function 53 converts the first authorisation request received from the first card scheme 40, which is a card present authorisation request, into a card not present authorisation request (second authorisation request) based on the second transaction card suitable for the issuer 80′. The mapping function 53 does this by using a set of rules provided by the rules database 54.

As for the embodiment of FIG. 2, the rules in the rules database 54 determine how to convert the first authorisation request into the second authorisation request. For example, the first card scheme 40 could be different to the second card scheme 70, and the content of an authorisation request suitable for the first and second card schemes could be different.

In addition, as described above, it will be appreciated that the first transaction card is associated with the local currency (British pounds) of the cardholder 10′. Hence, the first card scheme administrator 40 will recognise that the card holder 10′ is associated with British pounds because the issuer function 51 (i.e. the “issuer” of the first transaction card) would be registered as a UK “issuer”.

As a result, the first card scheme administrator 40 will apply a foreign exchange conversion to the transaction particulars in the first authorisation request, and indicate in the first authorisation request that a currency conversion is to take place. In other words, if the card holder 10′ is attempting to buy goods to the value of $150, the card scheme administrator 40′ will make a conversion and pass the authorisation request to the issuer function 51 requesting an amount of money in British pounds at a rate determined by the first card scheme administrator 40.

The mapping function 53 modifies the content of the first authorisation request so as to relate to a transaction in British pounds, as opposed to US dollars. The mapping function 53 also modifies the content of the first authorisation request in such a way so that the amount of money indicated in the converted first authorisation request does not require a currency conversion.

The mapping function converts the amount of money in US dollars to an amount of money in British pounds, based on foreign exchange information stored in the foreign exchange database 55.

Then, the mapping function 53 provides the converted first authorisation request to the merchant function 52. The merchant function 52 then provides a second authorisation request to the local acquirer 60′ (S15″) based on the converted first authorisation request.

Hence, this example, the second authorisation request is therefore a request for an amount of money in pounds that does not require any currency conversion, even though it relates to a first authorisation request for an amount of money in US dollars.

The local acquirer 60′ then provides the second authorisation request to the second card scheme 70 (S16″), which in turn provides the second authorisation request to the correct local issuer 80′, on the basis of the BIN number of the second transaction card. Hence, the mapping function 53 converts the first authorisation request based on a card present transaction associated with the card holder's first transaction card, and to a second authorisation request associated with the card holder's second transaction card.

The local issuer 80′ then queries the card holder's account 90′, and approves/declines the transaction on the basis of the funds available in the card holder account 90′ (S18″, S19″). The local issuer 80′ then sends a first authorisation response to the second card scheme 70 (S20″), relating to an amount in pounds. The second card scheme 70 then provides the first authorisation response to the local acquirer 60′ (S21″). The local acquirer 60′ then provides the merchant function 52 with the first authorisation response (S22″).

Then, the merchant function 52 provides the first authorisation response to the mapping function 53, which converts the first authorisation response into a second authorisation response relating to the card present transaction made by a cardholder 10′ using the information provided in the rules database 54. This process mirrors the process of converting the first authorisation request into the second authorisation request, and involves replacing values of data elements in the first authorisation response with those from the first authorisation request, in order to form the second authorisation response. The mapping function 53 also replaces the value in British pounds with the value in US dollars requested by the foreign merchant 20′.

In other words, the mapping function 53 converts the authorisation response from the local issuer 80′ into an authorisation response suitable for the merchant 20′ (S23″).

The issuer function 51 then sends the second authorisation response message to the first card scheme 40 (S24″), which in turn provides the second authorisation response message to the foreign acquirer 30′ (S25″), which then provides the response message to the foreign merchant 20′ (S26″). On the basis of the received second authorisation response, the transaction at the foreign merchant 20′ is then either approved or declined.

Hence, as a result of the arrangement of FIG. 5, the card holder 10′ is able to make a transaction at the foreign merchant 20′ using a first transaction card in the way of a card present transaction, with the card holder's local issuer 80′ being provided with a authorisation request associated with a card not present transaction associated with a second transaction card. Hence, the arrangement of FIG. 5 converts a card present transaction scheme into a card not present transaction scheme, while using a foreign exchange rate determined by the card processor 50b, as opposed to by the first card scheme 40 or by the foreign acquirer 30′.

It will be appreciated that the foreign merchant 20′ could be a retailer with appropriate point of sale equipment, or could be a foreign ATM. The same transaction flow would apply in each case.

It will also be appreciated that, although the above example has been discussed in terms of a local British pounds issuer and a foreign dollars merchant, the same transaction flow is appropriate whichever currencies are involved.

Furthermore, in the above example, the first card scheme 40 is aware that the issuer function 51 is associated with a different currency to the foreign merchant 20′, and hence sets an exchange rate in the first authorisation request. However, in some embodiments, the issuer function 51 could be associated with the same currency as the foreign merchant 20′, but a different currency to the local issuer. In such circumstances, the first card scheme 40 would not apply any currency conversion to the first authorisation request, and the first authorisation request would specify an amount in the currency of the foreign merchant 20′. The mapping function 53 would still, however, convert the amount in the currency of the foreign merchant 20′ to an amount in the currency of the local issuer 80′ based on the information in the foreign exchange database 55.

In addition, the issuer function 51 could be associated with a third currency that is different to the currency of the foreign merchant 20′ and the currency of the local issuer 80′. In such a case, the first card scheme 40 would apply a currency conversion in the first authorisation request to an amount in the currency associated with the issuer function 51. The mapping function 53 would then simply ignore this conversion and convert the amount in the currency of the foreign merchant 20′ to an amount in the currency of the local issuer 80′ based on the information in the foreign exchange database 55.

The Tables below show how card transactions can be converted from the use of the first transaction card (i.e. a transaction card specifically for use in embodiments of the invention) used overseas, to the customer's local debit or credit card (second transaction card). These tables relate to the Dual Message System, typically used for POS and E-Commerce transactions. The data elements that need to be changed will be specific for the card schemes 40 and 70 used by the first and second transaction cards. Additionally, it is possible that different merchants and acquirers may require different rules. All such information can be stored in the rules database 54.

The card mapping is based on the ability to convert card present POS/ATM transactions into card not present transactions (as used by e-Commerce services). Scenarios are provided for first transaction cards that have no chip-and-pin verification and transactions that use chip-and-pin for cardholder verification.

Table 1 shows an example data mapping for an authorisation request for a POS transaction with no chip-and-pin verification (i.e. no PIN or EMV verification) suitable for converting the first authorisation request (a card present transaction) in a first currency into the second authorisation request (a card not present transaction) in a second currency.

In Table 1, the data elements used in the authorisation request messages are mapped on a 1:1 basis between the foreign acquirer 30′ and the CNP transaction used by the merchant function 52.

The data elements requiring mapping from a currency perspective are shown in the Table 1. All transaction details from the originating merchant, i.e. from where the original transaction originates, must be mapped, persisted and retained to ensure that the merchant, purchase and other transaction details from the card present transaction can populate the transaction details for the CNP transaction (and also used for subsequent management information and reconciliation purposes).

The following data elements are merely illustrative, and should not be construed as limiting as embodiments of the invention. It will be appreciated that different card schemes, for example, require different data elements.

TABLE 1
Conversion from first authorisation request
to second authorisation request

| First Authorisation Request | Second Authorisation Request |
|---|---|
| Data Element | Data Element |
| DE 2 - First transaction card PAN | DE 2 - Second transaction card PAN |
| DE 3 - Processing Code | DE 3 - Processing Code |
| DE 4 - Transaction Amount | DE 4 - Local currency Transaction |
| (overseas currency) | Amount |
| | DE 6 - Cardholder Billing Amount |
| DE 7 - Transmission Date and | DE 7 - Transmission Date and |
| Time | Time |
| DE 10 | 61000000 |
| DE 11 - System Trace Audit | DE 11 - System Trace Audit |
| Number | Number |
| DE 43 - Card Acceptor Name/ | DE 43 - Card Acceptor Name/ |
| Location | Location |
| | Create CNP Location data |
| DE 49 - Currency Code | DE 49 - Local currency |
| | DE 51 - Cardholder Billing Currency |
| DE 48 - Additional Data, contains | DE 48 - Persist for CVV; map sub |
| TCC and CVV | element 42 |
| DE 18 - Merchant type | DE 18 - Merchant Type |
| DE 22 - POS Entry Mode | DE 22 - POS Entry Mode: Create |
| | CNP Transaction; map subfields |
| | 1 & 2 |
| DE 32 - Acquiring Institution | DE 32 - Acquiring Institution |
| ID Code | ID Code |
| | DE 33 - Forwarding Institution |
| | ID Code |
| DE 61 - POS Data | DE 61 - POS Data: Create CNP |
| | Transaction Data; map subfields |
| | 4 & 10 |

### DE2

DE2 is the data element is used for all numeric PANs up to 19 digits long when PAN is in Authorization/01xx messages, Reversal Advice/04xx messages, and Administrative Advice/06xx messages (when required). This data element data consists of three primary components:
Bank Identification Information (BIN)
Individual Account ID Number
PAN check digit

The first transaction card PAN is mapped to the second transaction card PAN depending on the settings defined by the customer when the second transaction card is registered to the card processor.

### DE3

DE3 is the data element that describes the effect of a transaction on the customer account and the type of accounts affected.

### DE4

DE4 is the data element that details the amount of funds the cardholder requested in the local currency of the acquirer. Whenever DE4 is used in an authorization message, the local currency of the card acceptor (the currency used by the cardholder and the merchant at the point of interaction) must always be specified using DE49 (Transaction Currency Code). This currency will be mapped to the local currency using the FX rates provided by the foreign exchange database 55.

### DE6

DE6 is the data element that indicates the transaction amount in the issuer's currency. It is the amount billed to the cardholder in the cardholder account currency exclusive of cardholder billing fees.

### DE7

DE7 is a transaction “time-stamp” the message originator supplies for each system transaction. It indicates the date and time that a system transaction is entered into an interchange network. DE7 must remain unchanged for all messages associated with a given system transaction, which includes all responses and acknowledgements.

### DE10

DE10 is the factor used in the conversion from transaction to cardholder billing amount. DE4 is multiplied by DE10 to determine DE6.

In this case, DE10 will be set to 61/000,000 in the second authorisation request, as this value indicates that no currency conversion required on transaction

### DE11

DEn is a number a message initiator assigns to uniquely identify a transaction. The trace number remains unchanged for all messages throughout the life of the transaction.

### DE43

DE43 contains the name and location of the card acceptor (e.g. merchant or ATM) that defines the point of interaction in both local and interchange environments.

DE43 is a mandatory field for all authorisation request/0100 messages for MasterCard (RTM) and Visa (RTM) programmes and services. When the CNP transaction is created, DE43 must be populated with the name and location data of the local acquirer 60′ (i.e. the acquirer for the second authorisation request).

### DE49

DE49 is the local currency of the acquirer or source location of the transaction. The currency code specified on the first authorisation request at point of transaction is mapped to the local currency code used by the local issuer 80′.

### DE51

DE51 defines the currency of Cardholder Billing Amount, DE6 and Cardholder Billing Fee, DE8. Both elements must map to the local currency of the local issuer 80′.

### DE48

DE48 provides other supplemental data in a message when a specific ISO-designated data element is not available. The two sub elements required are:
TCC—The TCC classifies major categories of transactions, such as “Retail Sale,” “Cash Disbursement,” and “Mail Order.”
Sub element 42, E-Commerce indicators will be used to map to a CNP transaction. Sub element 42 represents the security level and cardholder authentication associated with the transaction.

In the mapping, Sub element 42 must be set to 2, Electronic Commerce Service Indicator.

Sub element 92, CVV (card verification value) must be captured during the registration of the second transaction card at the card processor 50b to ensure that CNP transactions from the merchant function 52 can be completed using STP (straight through processing). Sub Element 92 is populated with the CVV captured when the second transaction card is pre-registered.

### DE18

DE18 is the classification of the merchant's type of business or service (the card acceptor business code/merchant category code [MCC]).

### DE22

DE22 consists of numeric codes to indicate the method by which the PAN was entered into the interchange system and to indicate the POS terminal PIN entry capabilities.

Subfield 1—POS Terminal PAN Entry Mode=1 (eCommerce including chip)

Subfield 2—POS Terminal PIN Entry Mode=2 (Terminal does not have PIN entry capability)

### DE32

DE32 identifies the acquiring institution (for example, merchant bank) or its agent. D 32 must contain a six-digit customer ID number assigned by the card scheme that identifies the institution acting as the “acquiring bank” or “merchant bank” for a transaction

### DE33

DE33 identifies the institution forwarding a Request or Advice message in an interchange system if it is not the same institution as specified in DE32.

DE33 is used within a message to contain the customer ID number of the Customer Processor System (i.e. the Merchant's POS ID) or INF (Intermediate Network Facility, i.e. the relating to the card system) responsible for directly routing that message to the Authorization System of the issuer function 51.

### DE61

This data element indicates the specific conditions that are present at the time a transaction took place at the point of service.

Set Subfield 4—POS Cardholder Presence=5 (electronic order), i.e. CNP Subfield 10—Cardholder Activated Terminal Level=6 (eCommerce)

On the response leg, the authorization request response is returned to the card processor 50b, which maps all response data elements to the second authorisation response message on a 1:1 basis;

Table 2 shows an example data mapping for an authorisation response suitable for converting the first authorisation response in the second currency into the first authorisation response in the first currency.

The data elements requiring mapping from a currency perspective are highlighted in the Table 2. All transaction details from the originating merchant, i.e. from where the original transaction originates, must be mapped, persisted and retained to ensure that the merchant, purchase and other transaction details from the CNP transaction can populate the transaction details for the card present transaction (and also used for subsequent management information and reconciliation purposes).

The process is the same for ‘Approved’ and ‘Decline’ responses.

TABLE 2
Conversion from first authorisation response
to second authorisation response

| First Authorisation Response | Second Authorisation Response |
|---|---|
| Data Element | Data Element |
| DE 2 - Second transaction card | DE 2 - First transaction card PAN |
| PAN | |
| DE 4 - Local Currency Transac- | DE 4 - Original Transaction amount |
| tion Amount | DE 6 - Original Transaction Amount |
| DE 43 - Local Acquirer Card | DE 43 - Original Card Acceptor Name/ |
| Acceptor Name/Location | Location |
| DE 49 - Local Currency Code | DE 49 - Original Currency Code |
| | DE 51 - Original Currency Code |
| DE 39 - Response Code | DE 39 - Response Code |
| DE 44 - Additional Response | DE 44 - Additional Response Code |
| Code | |
| DE 48 - Additional Data | DE 48 - Contains CVV |

### DE2

The response transaction must set all data in each Data Element to match the original request transaction. The second transaction card PAN is mapped to the first transaction card PAN as defined by the settings defined by the Customer when registering the second transaction card with the card processor 50.

### DE4

Since the issuer function 51 request transaction is converted to a CNP transaction, some of information held in the original Data Elements is lost. Data in each Data Element must therefore be persisted on the request leg of the transaction. This data is then used to populate Data Elements in the response leg of the transaction.

As a result, the original amount (from persisted data) is mapped to DE4 on the response leg of the transaction.

### DE6

As for DE4, use the original transaction amount from the authorisation request leg of the transaction (i.e. in the first authorisation request) is used to map DE6 for the response leg of the transaction (i.e. in the second authorisation response).

### DE43

CNP data in DE43 is replaced with the original card acceptor (e.g. merchant) name/location (from persisted data) in the response leg of transaction (i.e. in the second authorisation response).

### DE49

The original currency code in the first authorisation request is mapped (from persisted data) to the Currency Code Data Element DE49 on the response leg of transaction (i.e. in the second authorisation response).

### DE51

The original currency code in the first authorisation request is mapped (from persisted data) to the Currency Code Data Element DE51 on the response leg of transaction (i.e. in the second authorisation response).

The content of DE's 49, 50 and 51 are as follows:

49—transaction currency
50—settlement currency
51—cardholder billing currency

### DE39

Response codes are used to indicate approval or decline of a transaction. In the event an authorization is declined, the response code indicates the reason for the rejection. The value for the Response Code will be generated by the local acquirer 60′ during the CNP request response. The appropriate codes are:

### 00=Approved;

01-99=reasons for rejection

### DE44

In this data element the reasons for rejection are mapped from the first authorisation response to the second authorisation response if the DE39 in the first authorisation response does not equal 00.

### DE48

Sub element 87 in the response message may contain the CVV code captured during consumer card pre-registration. PIN data and data specific to EMV secured transactions are shown in Tables 1 and 2. EMV transactions use Data Elements 52, 53 and 55 to manage Chip and PIN information.

Such data is part of the data that needs to be registered in the card processor to generate the second authorisation response.

The issuer function 51 will use this data to verify each transaction. However, the PIN and EMV data is not required for the CNP transaction by the local acquirer 80′. In addition, the second authorization response send by the issuer function 51 to the foreign merchant 20′ does not need to include any PIN or EMV information. Hence there is no need to persist PIN or EMV data to complete the response leg of the transaction for the transaction to complete acceptably.

It is noted that Tables 1 and 2 of data element mappings below are illustrative, and are not intended to be complete or comprehensive. It will be appreciated that all transaction details from the originating merchant, i.e. from where the original transaction originates, must be mapped, persisted and retained to ensure that the merchant, purchase and other transaction details from the card present side of the transaction can populate the transaction details for the CNP transaction (and also used for subsequent management information and reconciliation purposes).

For transactions that use chip-and-pin for cardholder verification, the data element mappings shown in Tables 1 and 2 will be needed. In addition, Table 3 shows example additional data mappings for an authorisation request for a POS transaction with chip-and-pin verification suitable for converting the first authorisation request (a card present transaction) in a first currency into the second authorisation request (a card not present transaction) in a second currency.

TABLE 3
Conversion from first authorisation request
to second authorisation request

| First Authorisation Request | Second Authorisation Request |
|---|---|
| Data Element | Data Element |
| DE 52 - PIN Data | Not required on Request Response/ |
| | 0110, therefore no need to persist |
| DE 53 - Security Control | Not required for response |
| DE 55 - ICC Data (EMV data) | Request Response/0110 require |
| | conditional response. Therefore |
| | no need to persist. |

### DE52

DE 52 (Personal ID Number [PIN] Data) contains a number assigned to a cardholder intended to uniquely identify that cardholder at the point of interaction.

Because of strict security requirements implemented within the network environment, PINs are never transmitted “in the clear” as character data.

### DE53

DE 53 is used with PIN data to provide specific information about PIN block encoding and PIN data encryption to assist the issuer (or its agent) in processing PINs entered at the point of interaction.

### DE55

The issuer and the payment application on the chip use DE 55 (Integrated Circuit Card [ICC] System-Related Data) to communicate with each other during an Authorization Request/0110 and Authorization Request Response/0110. The data includes EMV data elements only the issuer or issuer agent is able to use.

The conversion from first authorisation response to second authorisation response for a POS transaction with chip-and-pin verification will be as above.

An example flow for the clearing and settling and settlement will now be described.

The Single Message System is predominantly used in ATM transactions. In the Single Message System (SMS), all original financial messages are managed through the use of cardholder transaction sets. A transaction set consists of the messages that relate to using a card at an ATM, the acquirer and the issuer. The SMS provides all three parties with the controls needed for real-time account posting and settlement.

All pertinent data elements in the Single Message System are equivalent to the Dual Message system (i.e. data element mappings remain the same); mappings described for POS and E-Commerce Authorization transactions are applicable to ATM transactions. However, Clearing for SMS and DMS messages requires each system to be handled distinctly, as discussed below.

### Single Message System

During the authorisation process, the card processor 50b will log the approved authorization information, with DE2 containing the first transaction card PAN, DE4 and DE49 containing the original cardholder billing amount and currency. All data elements mapped to the second transaction card, transaction amounts and currencies used on the card not present leg of the transaction must also be logged.

At the next clearing cycle cut-off, the foreign acquirer 3′ will generate the presentment records containing the overseas clearing transactions for cardholder posting. The records will contain the first transaction card PAN number in DE2. In addition, DE4 and DE49 will contain the cardholder billing amount and currency in the overseas currency.

Upon receipt of the file, the issuer function 51 processes each clearing record. Using the PAN in DE2, which identifies the card to which the clearing transaction is to be posted, the issuer function 51 matches the clearing record to the “held” authorization, releases the authorization hold, posts the DE4 and DE49 cardholder billing amount and currency, applies any related prepaid fees, and updates the open-to-buy balance of the first transaction card. Any authorisation holds are released.

The first card scheme 40 will then generate clearing information, which is sent to the issuer function 51 and the foreign acquirer 30′. The card processor 50b generates specific clearing information for the local currency, using the mapped fields DE2, DE6 and DE51, containing the amount in the first current and the currency code.

A standard settlement file will be generated by issuer function 51 and sent to the foreign acquirer 30′ in the overseas currency.

Two settlement files will be generated and sent to the card processor 50b for reconciliation. The first will contain the second transaction card PAN, the billing amount and currency of the local issuer 80′; the second settlement file will contain the first transaction card PAN, the foreign cardholder billing amount and currency (i.e. the amount that foreign merchant 20′ is expecting to receive).

This will enable the card processor 50b to reconcile funds used to settle approved transactions with foreign acquirer 30′ and the issuer function 51 in the foreign currency. The card processor 50b will use the second settlement file to reconcile funds used to settle between the local acquirer 60′ and the local issuer 80′ in the currency of the local issuer 80′.

### Dual Message System

The process for Dual Message transactions varies from the SMS in that clearing occurs later, when the foreign acquirer 30′ has submitted the clearing transaction for presentment. The first card scheme 40 may receive the clearing transaction in one of a batch of clearing files.

Upon receipt of the clearing file, the clearing system of the first card scheme 40 will process each clearing record. Using the PAN in DE2, the clearing system will match the clearing record to the “held” authorization, release the authorization hold, post the DE4 and DE49 cardholder billing amount and currency, apply any related prepaid fees, and update the open-to-buy balance of the funds available for purchasing. Transactions held are also released.

The clearing information generated by the first card scheme 40, is sent to the issuer function 51 and the foreign acquirer 30′. The card processor 50b generates specific clearing information for the currency of the local issuer 80′ using the mapped fields DE2, DE6 and DE51, containing the amount and currency used in the second authorisation response.

A standard Settlement File will be generated by the issuer function 51 and sent to the foreign acquirer 30′ in the overseas currency.

Two Settlement Files will be generated and sent to the card processor 50b for reconciliation. The first will contain the second transaction card PAN, the cardholder billing amount and currency for the local issuer 80′. The second settlement file will contain the first transaction card PAN, the foreign cardholder billing amount and currency.

This will enable the card processor 50b to reconcile funds used to settle approved transactions with foreign acquirer 30′ and the issuer function 51 in the foreign currency. The card processor 50b will use the second settlement file to reconcile funds used to settle between the local acquirer 60′ and the local issuer 80′ in the currency of the local issuer 80′.

Although some of the embodiments of the above discuss the conversion of a card present transaction with a first transaction card to a card not present transaction with a second transaction card, it will be appreciated that embodiments of the invention are equally applicable to the conversion of a card present transaction with a first transaction card to a card not present transaction with a second transaction card. Such scenarios could be used, for example, to use the first transaction card in an online transaction, while obtaining the funds from an account associated with the second transaction card.

As discussed, embodiments of the present invention provide a processing system that comprises an issuer function and a merchant function as part of a card processor. The issuer function is arranged to receive a first authorisation request from a first card scheme administrator associated with a first transaction card, the first authorisation request relating to a card transaction made by a cardholder at a card acceptor using the first transaction card and including a number of data elements. A mapping function is provided in the card processor that is arranged to convert the first authorisation request into a second authorisation request, the second authorisation request relating to a card not present transaction associated with a second transaction card, the second transaction card being associated with a second card scheme administrator and with an issuer, wherein the mapping function is arranged to change contents of at least some of the data elements of the first authorisation request to form the second authorisation request. The merchant function is arranged to send the second authorisation request to the issuer of the second transaction card via the second card scheme administrator, and to receive a first authorisation response from the second card scheme administrator, the first authorisation response including a number of data elements. The mapping function is then arranged to convert the first authorisation response into a second authorisation response, the second authorisation response relating to the card present transaction made by a cardholder, wherein the mapping function is arranged to change contents of at least some of the data elements of the first authorisation response to form the second authorisation response. The issuer function is arranged to send second authorisation response to the card acceptor via the first card scheme administrator. In such embodiments, the card acceptor could be a merchant (physical or online) or an ATM.

In such embodiments of the invention, the process is in real time, and the authorisation response to the card acceptor (i.e. the second authorisation response) is not provided by the issuer function until the authorisation response (i.e. the first authorisation response) is received by the merchant function.

In some of the above mentioned embodiments, the card processor converts a transaction with a first transaction card to a transaction associated with a second transaction card, using a card scheme associated with the second transaction card. However, it will be appreciated that embodiments of the invention are suitable for converting a transaction with a first transaction card to a transaction associated with an account, with that account not being associated with a second transaction card.

In such embodiments, the card processor will convert the first authorisation request relating to a card transaction made by a cardholder using the first transaction card into a second authorisation request relating to a transaction associated with an account associated with an institution (e.g. a bank or other financial institution).

An example of such an embodiment is shown in FIG. 7.

FIG. 7 shows a schematic diagram of a transaction processing system according to a third embodiment of the invention. In this figure, entities with the same function as those with FIG. 5 are shown with the same reference number.

In this embodiment there is a card holder 10″, a foreign merchant 20″, a foreign acquirer 30″, a first card scheme administrator 40, and a card processor 50b. The card processor 50b is connected to an account holding institution 80a and an account 90a held by that institution 80a.

In this example, the card holder 10″ wishes to buy goods from a foreign merchant 20″. For example, the card holder 10″ could be a UK resident, who is on holiday in the USA.

In the arrangement of FIG. 7, the card holder 10″ has one transaction card. The card holder 10″ has a first transaction card that is specially adapted for this embodiment of the present invention, and that identifies the issuer function 51 as the “issuer” of the first transaction card. The first transaction card is associated with the card scheme of the first card scheme administrator 40. In this embodiment, the first transaction card is a card linked to the local currency of the cardholder 10″. In some embodiments, the first transaction card can be capable of ‘dynamically’ adjusting its transacting currency to match the local currency of the foreign merchant 20″.

The card holder 10″ also has an account held with an institution that can carry out card-less transactions that require authorisation. An example of such a scheme could be a modification of the Faster Payments service in the UK modified to include an authorisation function. The card holder 10″ registers the account and associated details with the card processor 50b.

The process of FIG. 7 starts with the card holder 10″ presenting their transaction card to the foreign merchant 20″. For example, the card holder 10″ could swipe their transaction card through a POS terminal on the premises of the merchant 20″ (S10′″). Then, the POS terminal of the foreign merchant 20″ sends the account details and particulars of the transaction to the foreign acquirer 30″ (S11′″) in a first authorisation request. The transaction particulars may include the ID of the POS terminal, the ID of the foreign merchant 20″, the number of the first transaction card, the value of the requested transaction, and the currency of the requested transaction.

On receipt of the transaction particulars, the foreign acquirer 30″ sends the transaction particulars in the first authorisation request to the appropriate card scheme 40 (S12″). The card scheme 40, which can be considered as a first card scheme in FIG. 7, then examines the BIN number of the transaction card to determine the issuer associated with the transaction card.

As for the arrangement of FIG. 5, the first transaction card of the card holder 10″ is not associated with a conventional issuer. In the arrangement of FIG. 7, the first card scheme 40 will identify that the BIN number of the transaction card used by the card holder 10″ is associated with the issuer function 51 of the card processor 50b, as opposed to a conventional card issuer. Hence, the first card scheme 40 will send the transaction particulars in the first authorisation request to the issuer function 51 (S13′″), as if the issuer function 51 were a conventional issuer.

The role of the card processor 50b is to translate a first authorisation request made by the first transaction card in a card present transaction, into a second authorisation request for the account holding institution 80a, and to take care of the currency conversion required as a result of the card present transaction involving a foreign merchant 20″. The card processor 50b achieves this by means of the issuer function 51 and the merchant function 52, the mapping function 53, the rules database 54 and the foreign exchange database 55 shown in FIG. 6.

On receipt of the transaction particulars in the authorisation request, the issuer function 51 will process the message and pass it to the mapping function 53.

The mapping function 53 converts the first authorisation request received from the first card scheme 40, which is a card present authorisation request, into an authorisation request (second authorisation request) suitable for the account holding institution 80a. The mapping function 53 does this by using a set of rules provided by the rules database 54.

As for the embodiment of FIG. 5, the rules in the rules database 54 determine how to convert the first authorisation request into the second authorisation request. For example, in this case, the rules database 54 will include information for converting an authorisation request relating to card present transaction suitable for the first card scheme (first authorisation request) to an authorisation request in the format that is acceptable to the account holding institution 80a (second authorisation request).

In addition, as described above, it will be appreciated that the first transaction card is associated with the local currency (British pounds) of the cardholder 10″. Hence, the first card scheme administrator 40 will recognise that the card holder 10″ is associated with British pounds because the issuer function 51 (i.e. the “issuer” of the first transaction card) would be registered as a UK “issuer”.

As a result, the first card scheme administrator 40 will apply a foreign exchange conversion to the transaction particulars in the first authorisation request, and indicate in the first authorisation request that a currency conversion is to take place. In other words, if the card holder 10″ is attempting to buy goods to the value of $150, the card scheme administrator 40′ will make a conversion and pass the authorisation request to the issuer function 51 requesting an amount of money in British pounds at a rate determined by the first card scheme administrator 40.

The mapping function 53 modifies the content of the first authorisation request so as to relate to a transaction in British pounds, as opposed to US dollars. The mapping function 53 also modifies the content of the first authorisation request in such a way so that the amount of money indicated in the converted first authorisation request does not require a currency conversion. In some embodiments, the second authorisation request can be formed based on (but not using in an exact form) data from the first authorisation request. In other embodiments, the second authorisation request can be formed by copying at least a portion of the data of the first authorisation request.

The mapping function converts the amount of money in US dollars to an amount of money in British pounds, based on foreign exchange information stored in the foreign exchange database 55.

Then, the mapping function 53 provides the converted first authorisation request to the merchant function 52. The merchant function 52 then provides a second authorisation request to the account holding institution 80a (S15″) based on the converted first authorisation request.

Hence, this example, the second authorisation request is therefore a request for an amount of money in pounds that does not require any currency conversion, even though it relates to a first authorisation request for an amount of money in US dollars.

The account holding institution 80a then queries the card holder's account 90a, and approves/declines the transaction on the basis of the funds available in the card holder account 90a (S16′″, S17′″). The account holding institution 80a then sends a first authorisation response to the merchant function 52 (S18′″).

Then, the merchant function 52 provides the first authorisation response to the mapping function 53, which converts the first authorisation response into a second authorisation response relating to the card present transaction made by a cardholder 10″ using the information provided in the rules database 54. This process mirrors the process of converting the first authorisation request into the second authorisation request to form the second authorisation response. The mapping function 53 also replaces the value in British pounds with the value in US dollars requested by the foreign merchant 20′.

In other words, the mapping function 53 converts the authorisation response from the account holding institution 80a into an authorisation response suitable for the merchant 20″ (S19′″). In some embodiments, the second authorisation response can be formed based on (but not using in an exact form) data from the first authorisation response. In other embodiments, the second authorisation response can be formed by copying at least a portion of the data of the first authorisation response.

In some embodiments, the first authorisation request could simply indicate that the transaction is accepted or declined. In such circumstances, the mapping function 53 could simply use this information (e.g. along with information from the first authorisation request) to form the second authorisation response.

The issuer function 51 then sends the second authorisation response message to the first card scheme 40 (S20′″), which in turn provides the second authorisation response message to the foreign acquirer 30″ (S21′″), which then provides the response message to the foreign merchant 20″ (S22′″). On the basis of the received second authorisation response, the transaction at the foreign merchant 20″ is then either approved or declined.

Hence, as a result of the arrangement of FIG. 7, the card holder 10″ is able to make a transaction at the foreign merchant 20″ using a first transaction card in the way of a card present transaction, with the account holding institution 80a being provided with a suitable authorisation request. Hence, the arrangement of FIG. 7 converts a card present transaction scheme into a transaction scheme suitable for the account holding institution 80a, while using a foreign exchange rate determined by the card processor 50b, as opposed to by the first card scheme 40 or by the foreign acquirer 30″.

It will be appreciated that the foreign merchant 20″ could be a retailer with appropriate point of sale equipment, or could be a foreign ATM. The same transaction flow would apply in each case.

It will also be appreciated that, although the above example has been discussed in terms of a local British pounds issuer and a foreign dollars merchant, the same transaction flow is appropriate whichever currencies are involved.

Furthermore, it will be appreciated that the flow of FIG. 7 could be used if the foreign merchant were an online merchant. In such a case, the first authorisation request would be associated with a card not present transaction.

In addition, it will be appreciated that the flow of FIG. 7 could be used with a local merchant (i.e. a merchant with the same currency as that of the account at the institution 80a). In such a case, no currency conversion would be required.

Hence, in some embodiments of the invention, there is provided a processing system comprising an issuer function arranged to receive a first authorisation request from a first card scheme administrator associated with a first transaction card, the first authorisation request relating to a card transaction made by a cardholder using the first transaction card at a card acceptor and including a number of data elements. Also provided is a mapping function arranged to convert the first authorisation request into a second authorisation request, the second authorisation request relating to a transaction associated with an account held with an institution, wherein the mapping function is arranged to use contents of at least some of the data elements of the first authorisation request to form the second authorisation request. In addition, there is provided a merchant function arranged to send the second authorisation request to the institution of the account, and to receive a first authorisation response from the institution, the first authorisation response including a number of data elements. The mapping function is arranged to convert the first authorisation response into a second authorisation response, the second authorisation response relating to the card transaction made by a cardholder, wherein the mapping function is arranged to use contents of at least some of the data elements of the first authorisation response to form the second authorisation response. In addition, the issuer function is arranged to send second authorisation response to the card acceptor via the first card scheme administrator.

In such embodiments, the card acceptor could be a merchant (physical or online) or an ATM, or any other point of transaction. The process is in real time, and the authorisation response to the card acceptor (i.e. the second authorisation response) is not provided by the issuer function until the authorisation response (i.e. the first authorisation response) is received by the merchant function.

It will be appreciated that the hardware used by embodiments of the invention can take a number of different forms. For example, all the components of the card processor of embodiments of the invention could be provided by a single device, or different components of the card processor could be provided on separate devices. More generally, it will be appreciated that embodiments of the invention can provide a card processor that comprises one device or several devices in communication.

Many further variations and modifications will suggest themselves to those versed in the art upon making reference to the foregoing illustrative embodiments, which are given by way of example only, and which are not intended to limit the scope of the invention, that being determined by the appended claims

1. A processing system comprising:
an issuer function arranged to receive a first authorisation request from a first card scheme administrator associated with a first transaction card, the first authorisation request relating to a card transaction made by a cardholder using the first transaction card at a card acceptor and including a number of data elements;
a mapping function arranged to convert the first authorisation request into a second authorisation request, the second authorisation request relating to a transaction associated with an account held with an institution, wherein the mapping function is arranged to use contents of at least some of the data elements of the first authorisation request to form the second authorisation request;
a merchant function arranged to send the second authorisation request to the institution of the account, and to receive a first authorisation response from the institution, the first authorisation response including a number of data elements;
wherein the mapping function is arranged to convert the first authorisation response into a second authorisation response, the second authorisation response relating to the card transaction made by a cardholder, wherein the mapping function is arranged to use contents of at least some of the data elements of the first authorisation response to form the second authorisation response;
wherein the issuer function is arranged to send the second authorisation response to the card acceptor via the first card scheme administrator.

2. A processing system according to claim 1, wherein the first authorisation request relates to a card present transaction.

3. A processing system according to claim 1, wherein the second authorisation request relates to a card not present transaction associated with a second transaction card, the second transaction card being associated with a second card scheme administrator and with an issuer of the account, and wherein the merchant function is arranged to send the second authorisation request to the issuer of the second transaction card via the second card scheme administrator, and to receive a first authorisation response from the second card scheme administrator.

4. A processing system according to claim 3, wherein the merchant function arranged to send the second authorisation request to an acquirer or to the second card scheme administrator.

5. A processing system according to claim 1, further comprising a rules database, the rules database storing a set of rules used by the mapping function to covert the first authorisation request into the second authorisation request, and to covert the first authorisation response into the second authorisation response.

6. A processing system according to claim 1, wherein the mapping function is arranged to store the content of the data elements that are changed in the first authorisation request, and to use this stored content when converting the first authorisation response into the second authorisation response.

7. A processing system according to claim 1, wherein the card present transaction made by the cardholder at the merchant is associated with an amount in a first currency, and the account is associated with a second currency;
wherein to form the second authorisation request the mapping function is arranged to change a value of a data element of the first authorisation request indicating the amount in the first currency with a value indicating an amount in the second currency.

8. A processing system according to claim 7, further comprising a foreign exchange database arranged to store currency conversion information, wherein the mapping function is arranged to use the currency conversion information to change the value of the data element of the first authorisation request indicating the amount in the first currency with the value indicating the amount in the second currency.

9. A processing system according to claim 7, wherein on receipt of the first authorisation response, the mapping function is arranged to change the value of a data element of the first authorisation response indicating the amount in the second currency with the a value indicating the amount in the first currency.

10. A processing system according to claim 7, wherein the first authorisation request contains a data element indicating that the there is to a be conversion from the first currency to the second currency, and wherein the mapping function is arranged to change a value of the data element of the first authorisation request associated with the conversion from the first currency to the second currency with a value indicating that there is no currency conversion required to form the second authorisation request.

11. A processing system according to claim 7, wherein the issuer function is associated with a third currency, and wherein the first authorisation request contains a data element indicating that the there is to a be conversion from the first currency to the third currency, and wherein the mapping function is arranged to substitute a value of the data element of the first authorisation request associated with the conversion from the first currency to the second currency with a value indicating that there is no currency conversion required to form the second authorisation request.

12. A processing system according to claim 7, wherein the issuer function is associated with the same currency as the merchant.

13. A processing system according to claim 3, wherein the first and second card scheme administrator are part of the same or different card schemes.

14. A method of processing comprising:
using an issuer function to receive a first authorisation request from a first card scheme administrator associated with a first transaction card, the first authorisation request relating to a card transaction made by a cardholder using the first transaction card at a card acceptor and including a number of data elements;
using a mapping function to convert the first authorisation request into a second authorisation request, the second authorisation request relating to a transaction associated with an account held with an institution, wherein the mapping function is arranged to use contents of at least some of the data elements of the first authorisation request to form the second authorisation request;
using a merchant function to send the second authorisation request to the institution of the account, and to receive a first authorisation response from the institution, the first authorisation response including a number of data elements;
wherein the mapping function converts the first authorisation response into a second authorisation response, the second authorisation response relating to the card transaction made by a cardholder, wherein the mapping function uses contents of at least some of the data elements of the first authorisation response to form the second authorisation response;
wherein the issuer function sends the second authorisation response to the card acceptor via the first card scheme administrator.
